(19) United States
(12) Patent Application Publication
(10) Pub. No.: US 2026/0029523 A1
(43) Pub. Date: Jan. 29, 2026

(54) DISTRIBUTED RADAR SYSTEM

(71) Applicant: Richard Mitchell, Palos Verdes Estates, CA (US)

(72) Inventor: Richard Mitchell, Palos Verdes Estates, CA (US)

(21) Appl. No.: 18/783,916

(22) Filed: Jul. 25, 2024

(51) Int. Cl. G01S 13/46; G01S 7/02; G01S 13/87; G01S 13/88

(52) U.S. Cl. CPC G01S 13/46; G01S 7/0232; G01S 13/87; G01S 13/88; G01S 2013/466

(57) ABSTRACT

A configuration wherein multiple radars arc positioned along the flight corridor of a test object or objects. At any given time, three radars are used to accurately measure the location of each object via trilateration.

### BACKGROUND OF THE INVENTION

### 1. Field of the Invention

Distributed radar system wherein several individual radars are positioned along the flight corridor of a test object.

### 2. Description of the Prior Art

The US Army has been pursuing development of a new technology to replace its aging test range radars under the Range Radar Replacement Program (RRRP). Other than refurbishing some of the existing radars, the primary emphasis has been on developing a new technology that can acquire and accurately track multiple objects at long range. The technology being pursued is phased array radar, which includes the modem versions of active phased array radar (APAR), multifunction phased array radar (MPAR) and active electronically scanned array (AESA). However, in spite of a huge expenditure, nothing usable has resulted. New phased array radars are inappropriate for test range instruments for the following reasons:
1) White Sands Missile Range in New Mexico already has Multi-Object Tracking Radars (MOTRs);
2) New phased array radars will be very expensive to develop, operate and maintain;
3) It is overly complex for single-object tracking, which are the majority of test range missions;
4) Performance requirements lead to very high sensitivity (loop gain) and very high measurement accuracy, which in turn requires very high power, a large antenna, and a massive pedestal;
5) The combination of a massive pedestal and large antenna makes transportation and setup difficult and time consuming;
6) All objects must be acquired and tracked in real time and failure to acquire an object means that the object may as well not exist;
7) The available energy is shared by all objects in the track, reducing the performance on each object;
8) There is a low limit on the number of objects that can be simultaneously tracked, which may be inadequate for some missions;
9) The conventional (and simplest) approach to phased array radar is to use a burst of pulses in each beam position, but this causes gaps in the data when multiple objects are being tracked and these gaps preclude post-mission processing (e.g., spin and precession analysis, and damage assessment);
10) The radar can be designed to avoid these gaps, as with the MOTR, but at significant additional costs;
11) Even for the MOTR, the effective PRF on each object is reduced by the number of objects in track, which can cause the Doppler spectrum to fold upon itself and complicate the post-mission analysis;
12) It may not be possible to measure target dynamics (e.g., spin and precession) over the entire flight path;
13) Accurate alignment of the pedestal is a time-consuming task that must be repeated on a regular basis;
14) Atmospheric refraction limits the achievable accuracy at low angles;
15) Operation of the radars requires highly trained personnel;
16) Maintenance is a significant problem because of the system size and complexity; and
17) Maintenance problems are compounded when working outdoors.

What is desired is to provide an improved test range radar system which overcomes the deficiencies noted above.

### SUMMARY OF THE INVENTION

In accordance with the teachings of the present invention, several low-tech radars are distributed along the flight corridor, whereby all objects are seen by at least three radars. Each object is localized in three dimensions by measurements of range in a process called trilateration, a well-known concept. The novel features of these trilateration radars are as follows:
1) Range measurements are based on timing, which is extremely stable and easy to calibrate;
2) Trilateration accuracy is relatively independent of range as long as the radars are appropriately positioned;
3) The antenna beam can be wide to view multiple objects, which enables small antennas to be used;
4) The wide beam antennas do not have to be pointed very accurately;
5) The antenna pedestal is lightweight, so the radar can be installed on a small trailer;
6) High resolution waveforms are used to isolate multiple objects, favoring operating at X-band, which doesn't interfere with the existing C-band instrumentation radars;
7) Trilateration measurements can be verified with the use of additional radars (multilateration);
8) The additional radars provide redundancy in case one should fail;
9) There is no need for a boresight tower;
10) An object that is accurately located via trilateration can also be used to align other test range instruments;
11) Since the trilateration radars are inexpensive, several radars can be placed along the flight corridor for better coverage, reduced range, and improved accuracy;
12) The ranges will be much shorter than for any all-in-one radar that has to do everything so they can operate with much less power;
13) Trilateration is relatively immune to atmospheric propagation effects (refraction);
14) Very high trilateration accuracy is achievable, typically better than 30 cm in three dimensions; an effective angle error of less than 10 micro-radians at the distance of 30 km, which is at least an order of magnitude better than any all-in-one radar;
15) Target dynamics (e.g., spin and precession) can be measured over the entire flight path;
16) Measurements of missile attitude are possible via range differences;
17) High duty radio waveforms can be used to minimize peak power, which is also ideal for solid state amplifier technology;
18) Because of the low power, all microwave components can be mounted above the rotary mechanism. Only DC power and digital data need to be passed through that mechanism;
19) Interchangeable antennas of various sizes can be used to optimize performance for different missions;
20) Multiple objects are illuminated by the wide beam and there is no specific limit on the number that can be tracked in the post processing operation;
21) The data can be reprocessed after the mission to improve track performance and allow acquisition and analysis of weak objects (e.g., debris) that are not detectable in real time;
22) Trilateration does not require synchronization of the pulses among the radars (phasing);
23) No on-site personnel being required after the radars are installed;
24) The radars can be controlled remotely and much of the control can be automated;
25) The radars are highly reliable because of the use of solid-state amplifiers and simple electronics;
26) The radars are easy to maintain, which can be done indoors at a central facility;
27) All the microwave components are currently commercially available;
28) There is little risk associated with the development of these radars; and
29) The total cost of the trilateration radars, including development, operation, and maintenance, is considerably less than any new high-performance phased array radar.

Potential interference problems with so many radars operating simultaneously are avoided since the linear-FM (LFM) waveform is used to achieve the desired high resolution in range, which has the added benefit that its spectrum is highly concentrated, allowing several radars to operate in a wide tunable band (especially at X-band). Using up-sweep on some radars and down-sweep on others is another way to avoid interference.

### DESCRIPTION OF DRAWINGS

For a better understanding of the present invention as well as other objects and further features thereof, reference is made to the following description which is to be read in conjunction with the accompanying drawing wherein:

FIG. 1 illustrates an example of the ghosting problem with the trilateration system of the present invention;

FIG. 2 is a block diagram of the components utilized to create and process FMCW signals; and

FIG. 3 illustrates the interaction of four trilateration radars.

### DESCRIPTION OF THE INVENTION

Several radars are distributed along the flight corridor whereby all objects are seen by at least three radars. Each object is localized in three dimensions by measurements of range in a process called trilateration.

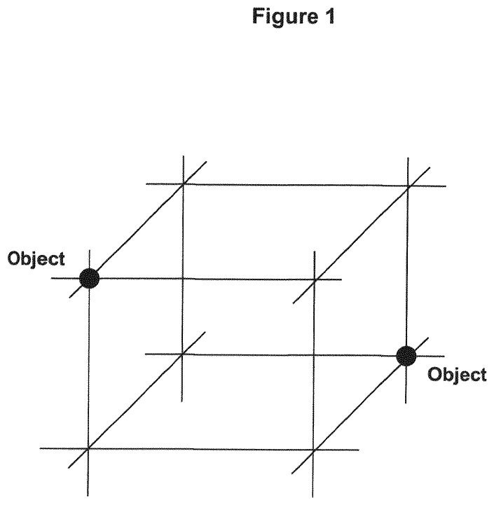

There is a ghosting problem with the trilateration concept when multiple objects are present. FIG. 1 shows range measurements made by two radars on two objects, everything being in a plane. There are four intersections, but only two represent the real objects, the other two being referred to as ghosts. Use of a third radar can resolve the two objects in this case. In three dimensions, four radars will be required to properly resolve the two objects.

The situation gets rapidly out of hand, however, whenever there are many objects. For M radars and N objects, there could be as many as N^{M} intersections to investigate, only N of which represent true solutions. Use of additional information, such as the signal amplitude and range rate measurements, can help to resolve the objects, but measurement errors can also lead to false solutions. The only reliable way to resolve the objects is to equip some radars with an angle measurement capability. Since only angle differences are needed to resolve the real objects from the ghosts, accurate alignment of the antennas is not an issue.

The present invention thus equips some radars with an angle measurement capability. For redundancy and to simplify the operation, logistics, and maintenance, all radars should be identical.

For most missions, it is relative accuracy that matters, not the absolute accuracy. With the use of a high-resolution waveform, trilateration radars can locate an object with an uncertainty of about 10 cm in three dimensions. This is an effective angle measurement precision of about 3 micro-radians at the distance of 30 km, which is about two orders of magnitude better than any high-tech, all-in-one radar.

Such high precision comes with a caveat, however, as it applies to dominant (isolated) scattering centers on otherwise large objects.

The best trilateration precision is obtained when the three range vectors are perpendicular to each other. Any other geometry diminishes the precision along each vector by 1/sin Θ, where Θ is the angle of that vector with respect to the plane defined by the other two vectors.

The low-tech trilateration radars can compete very favorably in detection performance with the existing FPS-16 radars, which have high-gain antennas and a peak power of several megawatts. But it is the signal energy that matters for detection purposes, and for the FPS-16s, detection is based on a single pulse as shown in Table 1.

TABLE 1
Signal Energy for FPS-16 Radar

| | | |
|---|---|---|
| Peak Power (Pₚₖ) | 3 | MW |
| Pulse Length (Tₚ) | 0.25 | μs |
| Signal Energy (E = PₚₖTₚ) | 0.75 | W-s |

For the trilateration radars, detection performance is also based on the signal energy, but in this case, it is the product of the average power and the coherent integration time. As shown in Table 2, with just 100 W of average power, these trilateration radars are able to utilize twice the energy for detection purposes than the FPS-16s. If the FPS-16s were to use a 1-μs pulse, the trilateration radars could also increase the coherent integration time to 60 ms to maintain the same advantage.

TABLE 2
Signal Energy for Trilateration Radar

| | | |
|---|---|---|
| Average Power (Pₐᵥ) | 100 | MW |
| Coherent Integration Time (T_{c}) | 15 | ms |
| Signal Energy (E = PₐᵥT_{c}) | 1.5 | W-s |

Detection performance (sensitivity) is given by the radar equation, which can be written in terms of the signal-to-noise ration as

$$SNR = [ E {G}^{2} {λ}^{2} σ ] \div [ {( 4 π )}^{3} {r}^{4} k T F L ]$$

Where E is the signal energy, G is the antenna gain, λ is the wavelength, σ is the target cross section, r is the range, k is Boltzmann's constant (1.4×10⁻²³ watt-sec/deg K), T is the reference temperature of 290 K, F is the receiver noise figure, and L represents the system losses. To compare the performance of the two radars, the quantity E G² λ²/r⁴ is only needed as the other factors should be pretty much the same for both radars.

Assuming that the trilateration radar operates at X-band, the width of its antenna will be just 2 ft (0.6 m). It is also assumed the range of the target is 10 km for the trilateration radar while the FPS-16 sees the same target at 50 km. Table 3 shows that both radars have essentially the same detection performance.

TABLE 3
Comparison of Radars

| | | |
|---|---|---|
| | FPS-16 | Trilateration |
| Parameter | Radar | Radar |

| | | | | |
|---|---|---|---|---|
| Signal Energy (E) | 0.75 | W-s | 1.5 | W-s |
| Antenna Width (w) | 4.9 | m | 0.6 | m |
| Wavelength (λ) | 0.055 | m | 0.03 | m |
| Antenna Beamwidth | 11 | mrad | 50 | mrad |
| (Θ_{b} = λ/w) | | | | |
| Antenna Gain | 50 | dB | 37 | dB |
| (G = 4 π/Θ_{b}²) | | | | |
| Range (r) | 50 | km | 10 | km |
| Combination | −114 | dBW-s-m⁻² | −114 | dBW-s-m⁻² |
| (E G² λ²/r⁴) | | | | |

Since range measurements are utilized to determine where the objects are, a fairly high resolution in range is required. The simplest way to implement high resolution, and the preferred method of this invention, is with the linear-FM (LFM) waveform.

As an illustration, a resolution of about one foot will provide a measurement accuracy of a few inches on an isolated point-like scatterer. For this resolution, the bandwidth of the LFM sweep should be about 600 MHz when weighting for controlling range sidelobes is included.

### Glossary of Terms

ADC Analog-to-digital converter, aka digitizer
AESA Active Electronically Scanned Array
APAR Active Phased Array Radar
BPF Band-pass filter
C-band Portion of the electromagnetic spectrum between 4 and 8 GHz
DDS Direct digital synthesizer
Down-sweep Linear frequency modulation with decreasing frequency versus time
FFT Fast Fourier transform
FM Frequency modulation
FMCW Frequency-modulated continuous wave, a type of waveform
GDOP Geometric Dilution of Precision
GHz Giga-Hertz (1,000,000,000 cycles per second)
Hz Hertz (cycle per second)
IF Intermediate frequency
kHz Kilo-Hertz (1,000 cycles per second)
LFM Linear frequency modulation
Linear-FM Linear frequency modulation
LO Local oscillator
LPF Low-pass filter
MHz Mega-Hertz (1,000,000 cycles per second)
MOTR Multi-Object Tracking Radar
MPAR Multifunction Phased Array Radar
PRF Pulse repetition frequency
RF Radio frequency, also radar frequency
RRRP Range Radar Replacement Program
Up-sweep Linear frequency modulation with increasing frequency versus time
X-band Portion of the electromagnetic spectrum between 9 and 12 GHz

If a pulsed waveform is used, the analog-to-digital converter (ADC) rate should be at least about three times the bandwidth, or about 1800 MHz, and to minimize the processing load downstream, it should be exactly four times, or 2400 MHz. Because of the high gain in the pulse compression process, an 8-bit device is adequate, but a huge amount of data needs to move around and record. Therefore, it is advantageous to compress the pulse in real time.

Pulse compression involves two fast Fourier transformations (FFTs), where the length of the second FFT can be 25% of the first when the ADC rate is exactly four times the sweep bandwidth. Although the signal will be critically sampled, complete fidelity will still be retained. For the ADC rate of 2400 MHz, the samples will be spaced by 0.25 m in range (there are 4000 samples in a 1 km range window).

With pulsed operation it is possible to utilize a duty ratio of 30%, which will minimize the peak power and make best use of solid-state power amplifier technology. Table 4 shows a schedule of waveform parameters that will provide seamless coverage in range from about 2 to 31 km. The numbers can be adjusted to avoid switching at a critical time during a mission. For the average power of 100 W (Table 2), the peak power will be 330 W.

TABLE 4
Example of Pulsed Waveform Schedule

| | Pulse | Processing | Processing |
|---|---|---|---|
| PRI | Length | Interval | Interval |
| (μs) | (μs) | (μs) | (km) |
| 40 | 12 | 13-26 | 1.95-3.90 |
| 80 | 24 | 26-52 | 3.90-7.80 |
| 160 | 48 | 52-104 | 7.80-15.60 |
| 320 | 96 | 104-208 | 15.60-31.20 |

With an ADC rate of 2400 MHz, there will be 28,800 samples in the 12-μs pulse and the length of the first FFT will be 32,768 samples. These numbers will double for each row in the table.

While this pulsed system is feasible, the FMCW system discussed next is much more practical.

There are several significant advantages in the use of the FMCW waveform over the pulsed waveform: (1) the microwave hardware is simpler, (2) much higher resolution is possible, (3) the peak power is lower for the same performance, (4) stretch processing can be used to compress the pulse, which involves only one fast Fourier transform (FFT), and (5) there is much more flexibility in the choice of waveform parameters. On the other hand, two antennas are needed instead of one, but this is a minor added expense for the small antennas.

Stretch processing is where the received signal is mixed with a delayed replica of the transmit waveform to remove the modulation. The remaining spectral components contain range information on the objects within a relatively narrow band. To obtain this range information, one takes a Fourier transform of the ADC output over the length of the LFM sweep. This processing step is usually called pulse compression even through the waveform is continuous. After mixing, the bandwidth of the IF signal is given by

$${B}_{if} = ( B / T ) Δ {τ}_{w} \qquad ( 1 )$$

Where T and B are the length and bandwidth of the LFM sweep, and Δτ_{w} is the width of delay window to be processed. The corresponding width of the window in range is

$$Δ {r}_{w} = ( c / 2 ) Δ {τ}_{w}$$

where c is the speed of light.

Designate fₛ as the sample rate of the analog-to-digital converter (ADC), when sampling is implemented with a single ADC (which is the preferred method), the constraint on fₛ is that it must be at least twice B_{if} according to the Nyquist criterion. It is customary to use weighting in the pulse compression process, which reduces the effective bandwidth of the signal slightly, so that setting fₛ=2B_{if} is possible. This is often called the critical sampling rate. The signal can be resampled with high fidelity in the post processing.

The number of samples being processed in the FFT to compress the pulse is given by

$$N = {f}_{s} T \qquad ( 2 )$$

where we can always add zeros to make a radix-2 number. Setting B_{if}=fₛ/2 in (1) and using (2)

BΔτ_{w}=N/2 is obtained
This means for a given value of N, the width of the window in delay Δτ is inversely proportional to the bandwidth B. Table 5 shows some of the waveform options for N=4000 (and an FFFT length of 4096). The sample rate (fₛ) and the length of the linear-FM sweep (T) are tied to this value. The range resolution numbers include the broadening effect when weighing is used in the pulse compression process.

TABLE 5
Selected Waveform Options for 4000 Samples in Pulse

| | | Range | Range |
|---|---|---|---|
| B | Δτ_{w} | Resolution | Window |
| (MHz) | (μs) | (m) | (m) |
| 125 | 16 | 1.60 | 2400 |
| 250 | 8 | 0.80 | 1200 |
| 500 | 4 | 0.40 | 600 |
| 1000 | 2 | 0.20 | 300 |
| 2000 | 1 | 0.10 | 150 |

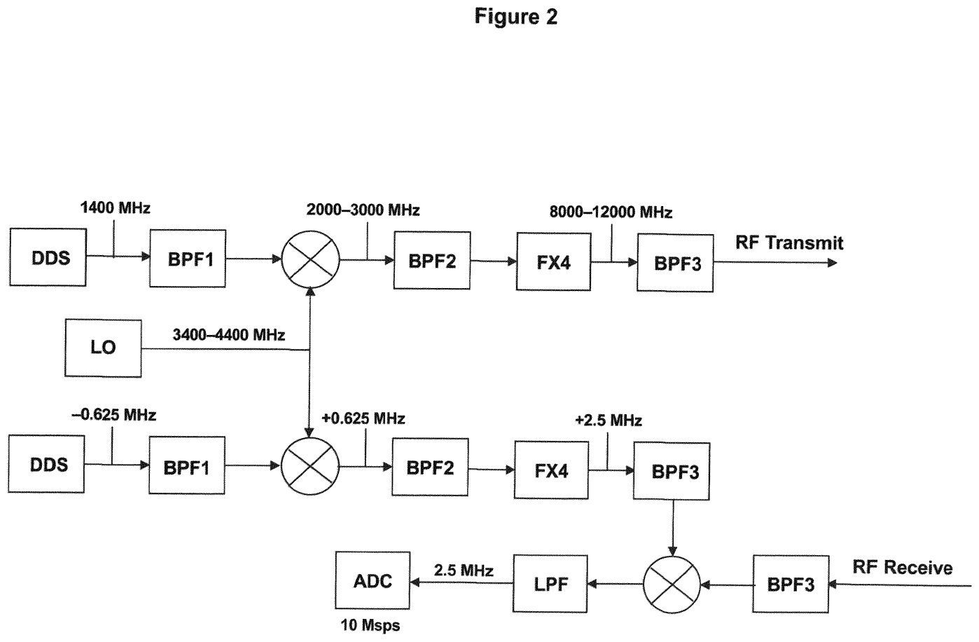

FIG. 2 illustrates how the signals can be created and processed at X-band with components that are commercially available. The numbers represent the center frequency of the LFM sweep at each stage (a master oscillator, amplifiers, and other signal conditioning devices are not shown).

Beginning at the top row in FIG. 2, the LFM waveform is generated in the direct digital synthesizer (DDS) with a sweep bandwidth centered at 900 MHz. This signal is bandpass filtered (BPF1) and mixed with a local oscillator (LO) that can vary from 2250 to 2900 MHz. The mixer output is bandpass filtered (BPF2) to retain the lower mixing product, then the resulting frequencies are multiplied by two and bandpass filtered again (BPF3), and finally these frequencies are multiplied by three and bandpass filtered (BPF4) to obtain a low-power version of the RF transmit signal. The LO frequency is constrained so that the broadband RF transmit signal is within 8000 and 12000 MHz. The final sweep bandwidth, which could be anywhere from a few hundred MHz to as much as 2000 MHz in this configuration, is six times the sweep bandwidth of the DDS.

The choice of the DDS center frequency and the design of the bandpass filter BPF2 are critical. The passband is from 1333 to 2000 MHz, which is ⅙th of the RF band from 8000 to 12000 MHz. For an RF bandwidth of 2000 MHz, the maximum in Table 5, the LFM sweep in the DDS will extend from 733 to 1066 MHz. Thus, BPF2 must suppress everything below 1066 MHz as well as above the lower limit of the LO of 2250 MHz.

The center row of components in FIG. 2 is identical to the top row. Here a delayed version of the LFM waveform is generated in this DDS, where the center frequency is 1.25 MHz below that used on transmit. The result at RF is a signal that is 7.5 MHz above what was transmitted. When this RF signal is mixed with the received signal, the FM sweep is removed and the result will be centered at 7.5 MHz. This analog signal is lowpass filtered (LPF) and digitized (ADC). The bottom row of components is replicated for each of the multiple receiver channels that are used for the angle measurements.

The DDS is manufactured by Analog Devices, model AD9914S. The frequency multipliers are by Minicircuits, models KSX2-722+ (multiply by 2) and RMK-3-153+ (multiply by 3).

The signal being sampled is real, so the FFT output from zero to fₛ/2 will be the mirror image of that from fₛ/2 to fₛ. Moreover, without the filter prior to the ADC, this condition will repeat in every spectral interval of width fₛ. The center of each of these spectral bands is given by

$${f}_{c} - ( k / 4 ) {f}_{s} \qquad ( 3 )$$

where k is an odd integer. The purpose of the filter prior to the ADC is to pass one of these bands and suppress all others.

The sample rate is fₛ=10 MHz because it is a commonly used oscillator frequency that can also support the DDS and LO devices. For k=3 in (3), the center frequency is f_{c}=7.5 MHz. The lowpass filter in FIG. 2 needs to pass everything between 5 and 10 MHz, and suppress everything above 15 MHz. From (4) for N=4000, the pulse length T=400 ρs and the waveform repetition rate, 1/T, will be 2500 Hz.

Other options for the center frequency are set forth in Table 6, where the filter before the ADC will now be bandpass. The best choice depends on the quality of the filter designed in the passband.

TABLE 6
Some Other Options for Center Frequency f_{c}

| | | | Stopband |
|---|---|---|---|
| | f_{c} | Passband | Edges |
| k | (MHz) | (MHz) | (MHz) |
| 5 | 12.5 | 10-15 | 5 & 20 |
| 7 | 17.5 | 15-20 | 10 & 25 |
| 9 | 22.5 | 20-25 | 15 & 30 |
| 11 | 27.5 | 25-30 | 20 & 35 |

The spacing of samples at the outpost of the FFT is Δf=fₛ/N, where N_{f} is the length of the FFT. This output scales as delay, where the sample spacing is

$$Δ τ = ( T / B ) Δ f = ( {f}_{s} T ) / ( {BN}_{fft} ) = ( 1 / B ) ( N / {N}_{f} )$$

The nominal resolution in delay is 1/B and the ratio N/Nr should be nearly unity.

The pulse compression via the FFT provides an integration gain of the product TB, which is at least 47 dB based on the numbers in Table 5. As a result, the received signal will be buried in the noise and only 8 bits is needed in the ADC. In this case, the data rate at the output of the ADC will be 80 Mb/s. Such data is easily passed through the rotary mechanism of the pedestal.

Most instrumentation radars operate at C-band (5.4-5.9 GHz). The trilateration radars should operate at X-band, between 8 and 12 GHz, where their output is bandpass filtered. Moreover, the waveguide for the C-band antennas is WR159, which has an upper cutoff frequency of 7.4 GHz. The waveguide for the X-band antennas is WR90, which has a lower cutoff frequency of 6.6 GHz. These radars will not interfere with each other. No radar should transmit directly at any other radar.

Some test range radars operate at X-band, but in a narrow part of that band. The operating, band of the trilateration radars can be chosen to avoid any conflict with these narrowband radars.

As noted above, the spectrum of the linear-FM signal is highly concentrated, which will allow several trilateration radars to operate simultaneously in a wide tunable band. For example, for the sweep bandwidth of 600 MHz and a band separation of 200 MHz, four trilateration radars operating within the tunable band of 9-12 GHz can be utilized.

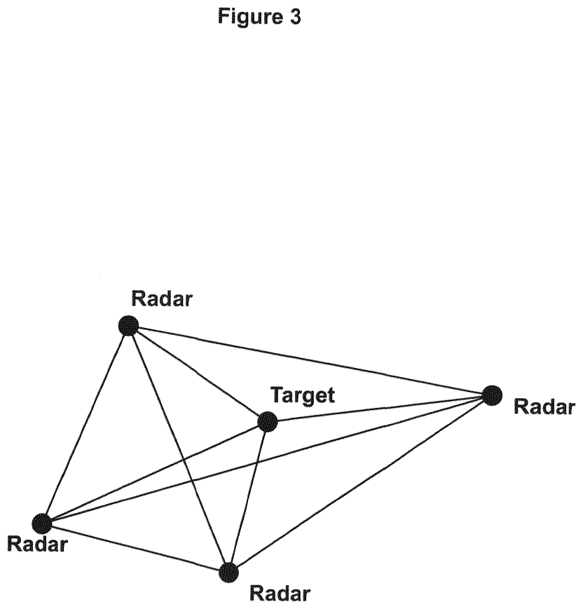

As illustrated in FIG. 3, four trilateration radars can operate simultaneously in the same band. Each radar will receive a total of seven signals: its own monostatic return, three direct transmissions from the other radars through antenna sidelobes, and three bistatic reflections from the target. By employing LFM up-sweep on two of the radars and a down-sweep on the other two, there will be only three competing signals that are correctly pulse compressed: the desired monostatic return, a direct transmission, and a bistatic reflection. The range for the direct transmission will not change and will be rejected by Doppler filtering. It is unlikely that the bistatic reflection will fall within the processing window in range that follows the target, but if it occurs the four trilateration measurements of location will not be in agreement.

In essence, as many as 16 trilateration radars operating simultaneously in four different parts of the overall band can be used without them interfering with each other.

Some missions may require a very high resolution such as the measurement of target attitude. This is another big advantage of the FMCW system over the pulsed system since the LFM bandwidth can be changed without affecting the ADC rate. The bandwidth of 2000 MHz, for example, will provide a resolution in range of about 10 cm (4 inches). Four trilateration radars can operate simultaneously with this bandwidth, without any interference issues. The only consequence of the large bandwidth is the narrow width of the range window of 150 m as shown in Table 5.

For such long pulses the return from a fast-moving target may distort the pulse compressed response. For most waveforms, the distortion is a broadening of the response, which degrades the resolution. However, the liner-FM waveform is an exception, since the result is just a bias in the range measurement that is proportional to the range rat. The resolution is not degraded.

In principle, some of the trilateration radars could operate in a bistatic receive-only mode, saving the cost of some of the transmitters. But the cost savings would be relatively small, which will not offset the complicated operational and signal processing issues facing bistatic operation. Except for the interchangeable antennas, all radars should be identical.

In essence, the distributed radar concept described above is applicable to any test range that employs radar. It is an affordable way to achieve much higher measurement performance than with any type of phased array radar.

While the invention has been described with reference to its preferred embodiment, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method of using three radars, each equipped with a range measurement capability, to locate an object in space via trilateration and tracking said object in three dimensions as it moves along its flight path.

2. The method of claim 1 wherein high resolution is employed by said radars to achieve high measurement accuracy.

3. The method of claim 2 wherein said radars employ a linear-FM waveform to achieve the high resolution, the waveform being either pulsed with gaps or continuous without gaps.

4. The method of claim 1 wherein very high resolution is employed to measure target attitude via range differences.

5. The method of claim 1 wherein said radars are used to measure the location of other objects in view and track these objects in three dimensions.

6. The method of claim 1 wherein certain of said radars are equipped with an angle measurement capability to resolve the true locations of multiple objects from false trilateration solutions.

7. The method of claim 6 wherein all said radars are equipped with an angle measurement capability for redundancy and to simplify the operation, logistics, and maintenance.

8. The method of claim 1 wherein an additional radar is used to verify the trilateration solution and also provide a solution in case one radar should become inoperable.

9. The method of claim 1, wherein multiple said radars are positioned along the flight corridor so that all objects of interest are seen by at least three radars at all times.

10. The method of claim 9 wherein certain of said radars utilize a linear-FM waveform with up-sweep and other radars utilize a linear-FM waveform with down-sweep to avoid interference.

11. The method of claim 9 wherein data are recorded by all said radars for post processing to improve track performance and allow acquisition and analysis of objects that are not detectable in real time.

12. The method of claim 9 wherein said radars utilize different portions of the overall frequency band to avoid interference.

13. The method of claim 9 wherein said radars are employed at a test range and receive pointing information from an existing test range asset.

14. The method of claim 13 wherein interchangeable antennas of various sizes are used to optimize performance for different missions.

15. The method of claim 13 wherein an object localized via trilateration is used to align other test range instruments.
